(19) United States
(12) Patent Application Publication
(10) Pub. No.: US 2019/0329759 A1
(43) Pub. Date: Oct. 31, 2019

(54) TRAVEL CONTROL DEVICE

(71) Applicant: ADVICS CO., LTD., Kariya-shi (JP)

(72) Inventor: Yusuke TAKEYA, Miyoshi-shi (JP)

(73) Assignee: ADVICS CO., LTD., Kariya-shi (JP)

(21) Appl. No.: 16/310,107

(22) PCT Filed: Jun. 23, 2017
(86) PCT No.: PCT/JP2017/023182

§ 371 Date: Dec. 14, 2018

(30) Foreign Application Priority Data
Jun. 23, 2016 (JP) 2016-124701

(51) Int. Cl. B60W 30/045; B60T 7/12; B60T 8/1755; B60W 10/184; B60W 10/20; B62D 6/00

(52) U.S. Cl. CPC B60W 30/045; B60T 7/12; B60T 8/1755; B60W 2710/20; B60W 10/20; B62D 6/00; B60W 2710/18; B60W 10/184

(57) ABSTRACT

A travel control device includes a first arithmetic unit configured to calculate a target moment, that is, a turning moment necessary for causing a vehicle to turn and move along a target path from a current position to a target position; a second arithmetic unit configured to calculate a limit moment, that is, a maximum turning moment which can be generated by a steering mechanism of the vehicle by the time the vehicle reaches the target position from the current position, while taking into account at least response delays of the vehicle; and an output unit configured to output brake commands for causing brake devices, which are respectively disposed so as to correspond to multiple wheels of the vehicle, to independently generate a braking force when the target moment is greater than the limit moment such that an insufficient moment corresponding to the difference between the target moment and the limit moment is generated.

### TECHNICAL FIELD

The present invention relates to a travel control device.

### BACKGROUND ART

Conventionally, in order to cause a vehicle to automatically travel along a predetermined target path regardless of a driving operation by a driver, a technique is known, in which a command for generating a steering torque corresponding to the target path is automatically issued to the vehicle.

### CITATION LIST

### Patent Literature

Patent Literature 1: JP-A-2012-11863

### SUMMARY OF INVENTION

### Technical Problem

In general, even if a command is issued to a vehicle, a time lag (behavior response delay) occurs until the vehicle actually starts a behavior in accordance with the command. Conventionally, such a behavior response delay was not taken into account. Therefore, even if a command for generating a steering torque corresponding to a target path is issued to the vehicle, there was a case where a desired steering torque cannot be obtained due to the behavior response delay and thus the vehicle cannot travel along the target path.

Accordingly, one of objects of the disclosure is to provide a travel control device, which can cause a vehicle to more accurately travel along a target path.

### Solution to Problem

A travel control device according to the disclosure includes, for example, a first arithmetic unit configured to calculate a target moment, which is a turning moment required to cause a vehicle to turn and move from a current position to a target position along a target path; a second arithmetic unit configured to calculate a limit moment, which is a maximum turning moment which can be generated by a steering mechanism of the vehicle until the vehicle arrives at the target position from the current position, while taking at least a behavior response delay of the vehicle into account; and an output unit configured to output a braking command for generating an independent braking force in a brake device provided for each of a plurality of wheels of the vehicle in order to generate a moment shortage corresponding to a difference between the target moment and the limit moment when the target moment is greater than the limit moment. Therefore, when a turning moment is insufficient due to at least the behavior response delay, it is possible to compensate a shortage in the turning moment using the brake devices having a relatively higher responsiveness, thereby causing the vehicle to more accurately travel along the target path.

### BRIEF DESCRIPTION OF DRAWINGS

FIG. 1 is an exemplary block diagram showing a schematic configuration of a vehicle equipped with a travel control device according to an embodiment.

FIG. 2 is an exemplary block diagram showing functional components of the travel control device according to the embodiment.

FIG. 3 is an exemplary view explaining a path tracking control realized in the embodiment.

FIG. 4 is an exemplary flowchart showing a process executed by the travel control device according to the embodiment.

### DESCRIPTION OF EMBODIMENTS

Hereinafter, embodiments will be described with reference to the accompanying drawings. The configurations of the embodiments described below and the operation and results (effects) obtained by the configurations are merely examples and are not limited to the contents described below.

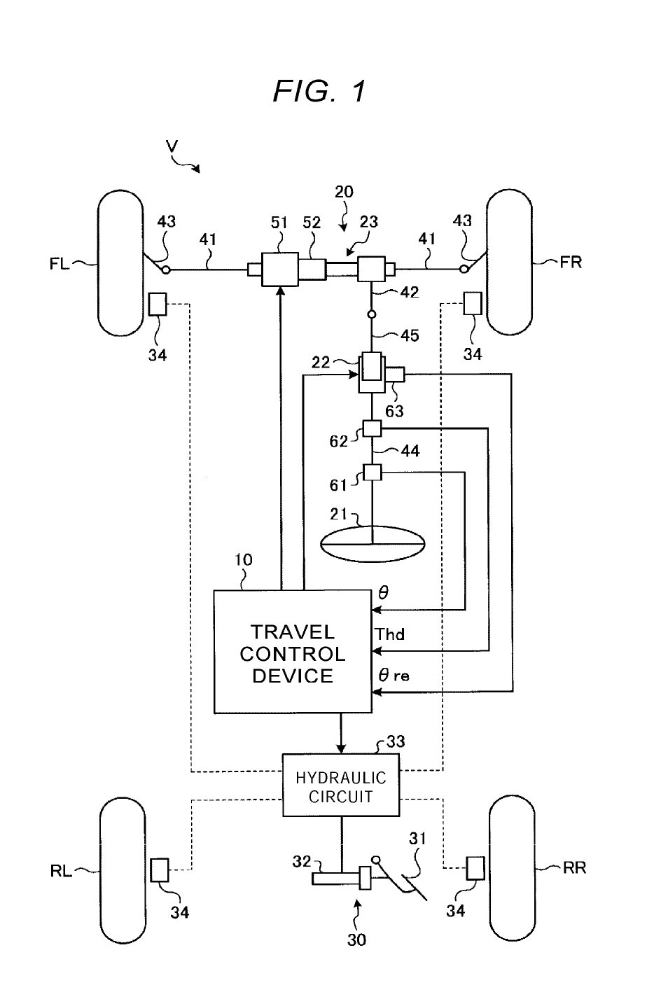

FIG. 1 is an exemplary block diagram showing a schematic configuration of a vehicle V equipped with a travel control device 10 according to an embodiment. As shown in FIG. 1, the vehicle V is a four-wheeled automobile having two left and right front wheels FL, FR and two left and right rear wheels RL, RR. In the following, the front wheels FL, FR and the rear wheels RL, RR are often collectively referred to as “wheels”. The vehicle V is mainly provided with the travel control device 10, a steering mechanism 20 and a brake mechanism 30.

The steering mechanism 20 is configured to control (change or maintain) a steering angle of the vehicle V based on steering by a driver or a steering command from the travel control device 10. In the example of FIG. 1, the steering angle of the vehicle V corresponds to a turning angle of the front wheels FL, FR, which are steered wheels.

The steering mechanism 20 illustrated in FIG. 1 is a so-called rack-and-pinion type steering mechanism, in which control of the steering angle of the vehicle V is realized using a rack bar 41 and a pinion shaft 42. That is, in the example of FIG. 1, if rotation of the pinion shaft 42 or the like occurs, the rack bar 42 reciprocates accordingly. Then, if the rack bar 41 reciprocates, a tie rod 43 connected to the rack bar 41 oscillates so that the steered wheels (front wheels FL, FR) of the vehicle V is steered.

More specifically, the steering mechanism 20 according to the embodiment mainly includes a steering wheel 21, a steering angle varying device 22 and a power steering device 23.

The steering wheel 21 is configured to receive steering by a driver. The steering wheel 21 is connected to the pinion shaft 42 via an upper shaft 44, the steering angle varying device 22 and a lower shaft 45.

The steering angle varying device 22 has an electric motor (not shown) operating in response to a command from the travel control device 10 and thus is configured to control the steering angle of the vehicle V by means of the electric motor without depending on steering of the steering wheel 21 by a driver. The steering angle varying device 22 is connected to the steering wheel 21 via the upper shaft 44 and also connected to the pinion shaft 42 via the lower shaft 45.

The power steering device 23 is configured to amplify a steering torque generated in accordance with steering of the steering wheel 21 by a driver and thus to be able to execute an assist in steering by the driver. The power steering device 23 includes an electric motor 51 operating in response to a command from the travel control device 10 and a conversion mechanism 52 for converting a rotational torque, which is generated in the electric motor 51, into a force acting in a reciprocating direction of the rack bar 41.

In addition, in the example of FIG. 1, the upper shaft 44 is provided with a steering angle sensor 61 for detecting a rotational angle of the upper shaft 44 as a steering angle A demanded by a driver, and a steering torque sensor 62 for detecting a torque, which is generated by rotation of the upper shaft 44, as a steering torque Thd inputted by the driver. Further, the steering angle varying device 22 is provided with a rotational angle sensor 63 for detecting a rotational angle θre of the lower shaft 45 relative to the upper shaft 44. Detection results of these sensors are inputted to the travel control device 10.

The brake mechanism 30 is configured to control a braking force generated in the vehicle V based on a braking operation by a driver or a braking command from the travel control device 10. The brake mechanism 30 includes a brake pedal 31, a master cylinder 32, a hydraulic circuit 33, and four wheel cylinders 34.

The brake pedal 31 is configured to receive a braking operation (stepping-on operation or stepping-back operation) by a driver. The master cylinder 32 is configured to convert a stepping force of the driver into a hydraulic pressure. The hydraulic circuit 33 is configured to distribute the hydraulic pressure of the master cylinder 32 to four wheel cylinders 34. In addition, the hydraulic circuit 33 has an oil reservoir, an oil pump, valves and the like (all not shown) and is configured to be able to increase or decrease hydraulic pressures of the wheel cylinders 34 in response to a command from the travel control device 10. The wheel cylinders 34 are operated based on hydraulic pressures distributed from the hydraulic circuit 33, thereby generating a frictional force or the like in the respective wheels and thus generating a braking force in the vehicle V.

The travel control device 10 outputs a steering command and a braking command to the steering mechanism 20 and the brake mechanism 30, respectively, thereby controlling traveling of the vehicle V. The travel control device 10 may be constituted of a plurality of ECUs (Electronic Control Units), such as a steering ECU for controlling the steering mechanism 20 and a braking ECU for controlling the brake mechanism 30 and the like, and also may be constituted of a single ECU for collectively controlling the steering mechanism 20, the brake mechanism 30 and the like.

Herein, the travel control device 10 according to the embodiment is configured to be able to execute a path tracking control for travelling the vehicle V along a predetermined target path regardless of steering by a driver, for example, when it is necessary to urgently avoid a preceding vehicle or the like. The target path is determined based on information inputted, for example, from an in-vehicle camera (not shown) capable of acquiring information on the surroundings of the vehicle V or the like.

By the way, the vehicle V is an object having a certain size. Therefore, even when the steered wheels (in the example of FIG. 1, front wheels FL, FR) are steered, delay based on a kinematic characteristic of the vehicle V occurs until the behavior thereof is actually started. Also, the steering mechanism 20 is a machine which operates mechanically or electrically. Therefore, even when steering by a driver or a steering command by the travel control device 10 is executed, delay based on mechanical or electrical operation of the steering mechanism 20 occurs until the behavior is actually started. Further, if the travel control device 10 is embodied by a plurality of ECUs, delay in communication via CAN (Controller Area Network) and the like, which is executed between the plurality of ECUs, also occurs.

The behavior response delay of the vehicle V constituted of several types of delay as described is the reason that the vehicle V does not travel along the target path during execution of the path tracking control. Herein, as described above, a case where the path tracking control is required is, for example, a case where it is necessary to urgently avoid a preceding vehicle. In such a case, a great trouble is likely to occur if the vehicle V does not travel along the target path. Therefore, in the embodiment, it is preferable that the path tracking control is executed while taking at least the behavior response delay into account, thereby more reliably causing the vehicle V to travel along the target path.

Thus, the travel control device 10 according to the embodiment realizes the path tracking control taking at least the behavior response delay into account by configurations as described below.

Specifically, the travel control device 10 calculates two moments including a target moment and a limit moment. Herein, the target moment is a turning moment required to cause the vehicle V to turn and move from a current position to a target position along the target path. The limit moment is a maximum turning moment, which is calculated while taking at least the behavior response delay of the vehicle V into account and can be generated by the steering mechanism 20 until the vehicle V arrives at the target position from the current position.

When the target moment is greater than the limit moment, a shortage in the turning moment has to be compensated in any way, or else it is impossible to square a traveling path of the vehicle V with the target path. Accordingly, when the target moment is greater than the limit moment, the travel control device 10 generates a moment shortage, which corresponds to a difference between the target moment and the limit moment, using the brake mechanism 30 generally having a responsiveness higher than that of the steering mechanism 20.

Meanwhile, the brake mechanism 30 according to the embodiment is configured to generate an independent braking force in each of the wheel cylinders 34 as brake devices provided for the respective four wheels, so that a turning moment can be generated in the vehicle V. A relationship between a turning moment to be generated in the vehicle V and distribution of the barking force to be generated in each of the wheel cylinders 34 can be calculated by a method using a tire model and the like as proposed conventionally (e.g., see Japanese Patent Application Publication No. 2002-173014).

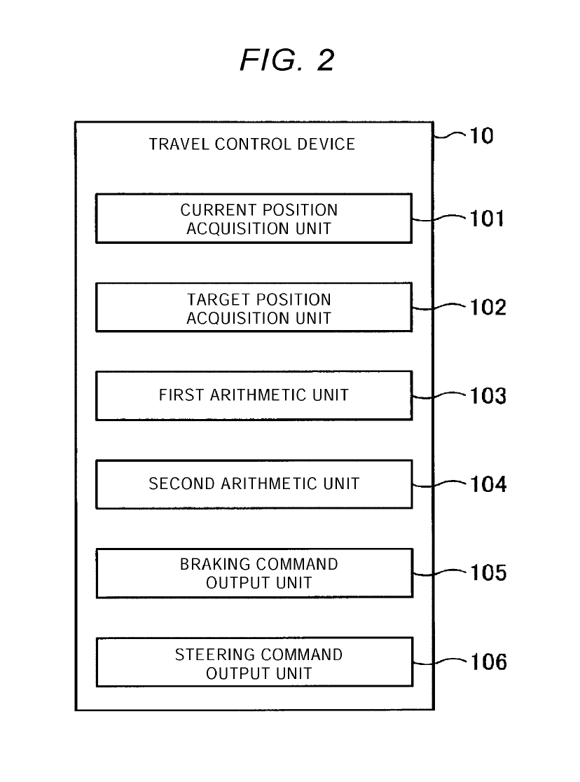

FIG. 2 is an exemplary block diagram showing functional components of the travel control device 10 according to the embodiment. The ECU constituting the travel control device 10 has a processor capable of executing various arithmetic processing and thus is configured such that the processor reads out a program stored (installed) in a memory and then executes the arithmetic processing in accordance with the program, thereby realizing the following functional components.

As shown in FIG. 2, the traveling control device 10 includes, as the functional components, a current position acquisition unit 101, a target position acquisition unit 102, a first arithmetic unit 103, a second arithmetic unit 104, a braking command output unit 105 and a steering command output unit 106. These functional components may be shared and realized by a plurality of ECUs or realized by a single ECU.

The current position acquisition unit 101 is configured to acquire a current position of the vehicle V. The current position can be acquired, such as by integrating detection results of a speed sensor (not shown) or using GPS (Global Positioning System).

The target position acquisition unit 102 is configured to acquire a target position of the vehicle V. Herein, the target position is a position, which is determined based on the target path and located within the target path and at which the vehicle V at the current position has to arrive after a predetermined time t. When the vehicle V arrives at the latest acquired target position, the target position acquisition unit 102 acquires the next target position. That is, the target position acquisition unit 102 acquires a new target position every a predetermined time t based on the target path.

The first arithmetic unit 103 is configured to calculate the target moment, which is a turning moment required to cause the vehicle V to turn and move from the current position to the target position along the target path.

The second arithmetic unit 104 is configured to calculate the limit moment, which is a maximum turning moment which can be generated by the steering mechanism 20 until the vehicle V arrives at the target position from the current position, while taking at least the behavior response delay of the vehicle V into account. Meanwhile, in the embodiment, the behavior response delay of the vehicle V may have a preset constant value or may have a variable value calculated based on various parameters, which can be acquired (estimated) by sensors and the like, such as a friction coefficient μ of a road surface, a temperature of the road surface or a wear degree of tires.

By the way, a steering ability, which the steering mechanism 20 can exhibit, is varied in accordance with a condition of the vehicle V. For example, a maximum steering angle, which the steering mechanism 20 can apply to the vehicle V, can be considered as one example of the steering ability. The maximum steering angle, which the steering mechanism 20 can apply to the vehicle V, is determined in relation to the condition of the vehicle V, such as a current steering angle of the vehicle V. Thus, as the condition of the vehicle V is varied, the maximum steering angle, which the steering mechanism 20 can apply to the vehicle V, is also varied, and as a result, the limit moment, which the steering mechanism 20 can generate, is varied as well. Therefore, in order to more accurately calculate the limit moment, it is necessary to take the steering ability of the steering mechanism 20 into account, in addition to the behavior response delay of the vehicle V.

For this reason, the second arithmetic unit 104 according to the embodiment takes into account both the behavior response delay of the vehicle V and the steering ability, which the steering mechanism 20 can exhibit in accordance with the condition of the vehicle V, thereby more accurately calculating the limit moment.

The braking command output unit 105 is configured to output a braking command to the brake mechanism 30. When the target moment is greater than the limit moment during execution of the path tracking control, the braking command output unit 105 according to the embodiment outputs a braking command for generating an independent braking force in each of the wheel cylinders 34 provided for the respective four wheels of the vehicle V, thereby generating a moment shortage corresponding to a difference between the target moment and the limit moment.

The steering command output unit 106 is configured to output a steering command to the steering mechanism 20. During execution of the path tracking control, the steering command output unit 106 according to the embodiment outputs a steering command to the steering mechanism 20 to generate a turning moment, which corresponds to the target moment, to the vehicle V. Meanwhile, as described above, the steering mechanism 20 cannot generate a turning moment greater than the limit moment. Thus, when the target moment is greater than the limit moment, a turning moment actually generated by the steering mechanism 20 is the limit moment.

Due to the above configuration, the present embodiment makes it possible to cause the vehicle V to travel along the target path.

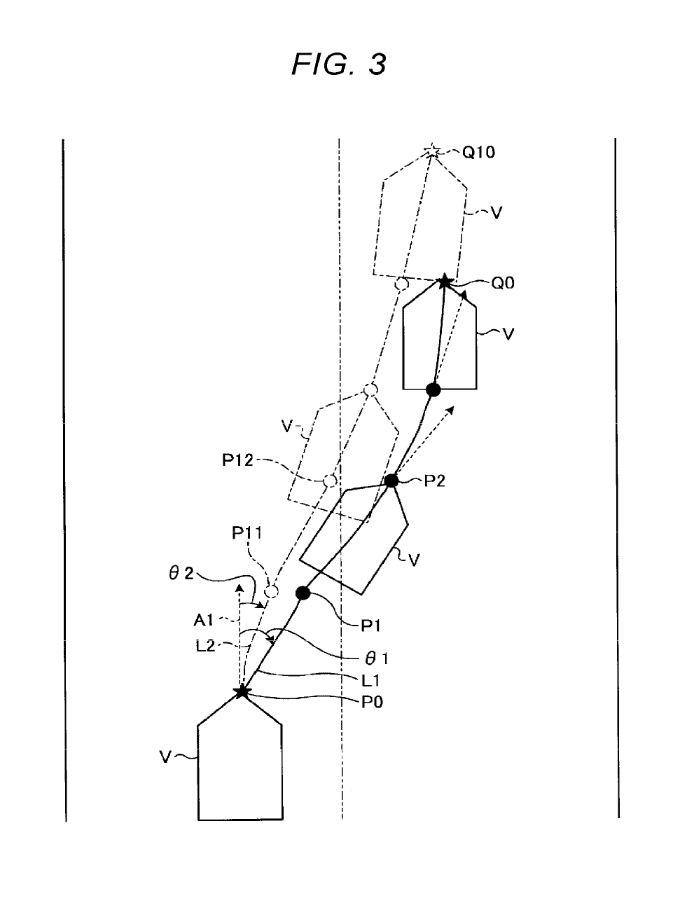

FIG. 3 is an exemplary view explaining the path tracking control realized in the embodiment. In the example of FIG. 3, a solid line L1 passing through points P0, P1, P2, . . . represents a target path set in the path tracking control. As shown in FIG. 3, when a vehicle V is positioned at a position of a point P0, the vehicle V executes the path tracking control, in which a point P1 in the solid line L1 representing the target path is set as a target position.

Herein, when attempting to cause the vehicle V to turn and move from the point P0 to the point P1, it is necessary to turn the vehicle V by an angle θ1 with respect to a dotted line arrow A1, which represents a current traveling direction of the vehicle V. Accordingly, it is necessary to generate a turning moment, which corresponds to the angle θ1, as a target moment. However, even when attempting to turn the vehicle V by the angle θ1, only a turning moment, which corresponds to an angle θ2 smaller than the angle θ1, is likely to be generated due to causes, such as a behavior response delay of the vehicle V and a limitation in steering ability of the steering mechanism 20. In this case, a position, at which the vehicle V will arrive, is a point P11 along a one-dot chain line L2 starting from the point P0 and thus deviates from the point P1, which is the target position.

Accordingly, in the embodiment, it is possible to generate a turning moment corresponding to a difference between the angle θ1 and the angle θ2 by the brake mechanism 30 due to the configuration as described above, thereby compensating the turning moment shortage. Therefore, the vehicle V, which would have turned and moved only to the point P11 along the one-dot chain line L2 if a conventional path tracking control, to which the technique of the embodiment is not applied, had been executed, can be turned and moved to the point P1, which is the target position, along the solid line L1 representing the target path. Accordingly, it is possible to avoid deviation of the arrival position of the vehicle V from the target position.

Meanwhile, in the case where the technique of the embodiment is not applied, deviation of the arrival position of the vehicle V is increased as traveling of the vehicle V is further progressed. For example, when comparing the solid line L1 with the one-dot chain line L2 in the example of FIG. 3, deviation between a point P2 and a point P12, which are arrival positions next to the point P1 and the point P11, respectively, is greater than deviation between the point P1 and the point P11, and also deviation between a point Q0 and a point Q10, which are final arrival positions, is even greater than deviation between the point P2 and the point P12. As described above, in the technique of the embodiment, the target position is updated every a predetermined time t, and also whenever the vehicle V arrives at the target position, a turning moment required to cause the vehicle V to turn and move to the next new target position is generated using the steering mechanism 20 (also using the brake mechanism 30 if necessary). Therefore, according to the technique of the embodiment, it is possible to avoid an increase in deviation of the arrival position of the vehicle V as traveling of the vehicle V is further progressed.

Next, control operations executed in the embodiment will be described.

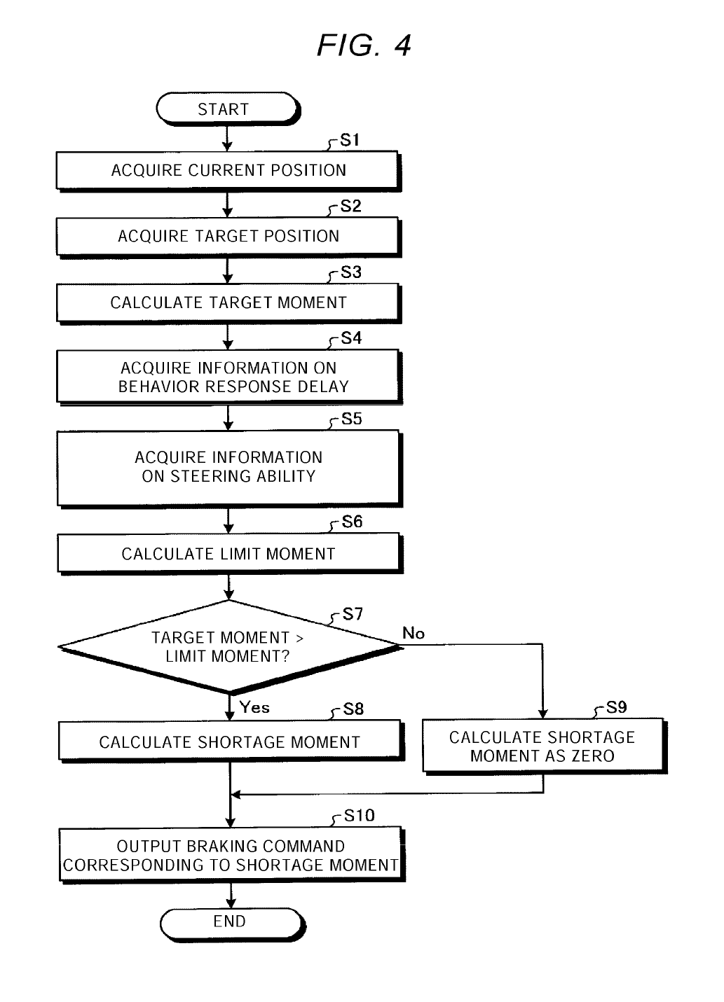

FIG. 4 is an exemplary flowchart showing a process executed by the travel control device 10 according to the embodiment. The process flow of FIG. 4 is executed repeatedly (at a cycle corresponding to the predetermined time t) while the path tracking control is executed.

In the process flow of FIG. 4, first, at S1, the current position acquisition unit 101 acquires a current position of the vehicle V.

Then, at S2, the target position acquisition unit 102 acquires a target position. As described above, the target position is a position, which is located within the target path and at which the vehicle V at the current position has to arrive after the predetermined time t.

Then, at S3, the first arithmetic unit 103 calculates a target moment, which is a turning moment required to cause the vehicle V to turn and move from the current position to the target position along the target path.

Then, at S4, the second arithmetic unit 104 acquires information on the behavior response delay of the vehicle V. As described above, the behavior response delay includes delay based on a kinematic characteristic of the vehicle V, delay based on mechanical or electrical operation of the steering mechanism 20 and the like.

Then, at S5, the second arithmetic unit 104 acquires information on the steering ability, which the steering mechanism 20 can exhibit in accordance with the condition of the vehicle V. As described above, the steering ability is, for example, a maximum steering angle, which is determined in relation to a current steering angle of the vehicle V and can be applied to the vehicle V at the current position by the steering mechanism 20.

Then, at S6, the second arithmetic unit 104 calculates a limit moment, which is a maximum turning moment which can be generated by the steering mechanism 20 until the vehicle V arrives at the target position from the current position, while taking into account both the behavior response delay of the vehicle V and the steering ability, which the steering mechanism 20 can exhibit in accordance with the condition of the vehicle V.

Then, at S7, the braking command output unit 105 decides whether or not the target moment is greater than the limit moment.

If it is decided at S7 that the target moment is greater than the limit moment, the process proceeds to S8. Then, at S8, the braking command output unit 105 acquires a difference between the target moment and the limit moment and thus calculates a moment shortage.

If it is decided at S7 that the target moment is equal to or smaller than the limit moment, the process proceeds to S9. Then, at S9, the braking command output unit 105 calculates the moment shortage as zero.

If the processing at S8 or S9 is ended, the process proceeds to S10. Then, at S10, the braking command output unit 105 outputs a braking command, which corresponds to the moment shortage calculated at S8 or S9, to the brake mechanism 30.

More specifically, when the target moment is greater than the limit moment, at S10, the braking command output unit 105 outputs a braking command corresponding to the moment shortage, which corresponds to the difference between the target moment and the limit moment, thereby generating the moment shortage. Meanwhile, at this time, it goes without saying that the steering command output unit 106 outputs a steering command for generating the limit moment to the steering mechanism 20.

On the other hand, when the target moment is equal to or smaller than the limit moment, at S10, the braking command output unit 105 outputs a braking command for not generating a turning moment, since the shortage moment is calculated as zero. Meanwhile, at this time, it goes without saying that the steering command output unit 106 outputs a steering command for generating the target moment to the steering mechanism 20.

In this way, the process executed by the travel control device 10 according to the embodiment is ended.

As set forth above, the travel control device 10 according to the embodiment includes the first arithmetic unit 103 configured to calculate a target moment, which is a turning moment required to cause the vehicle V to turn and move to a target position along the target path; and the second arithmetic unit 104 configured to calculate a limit moment, which is a maximum turning moment which can be generated by the steering mechanism 20 of the vehicle V until the vehicle V arrives at the target position from the current position, while taking at least the behavior response delay of the vehicle V into account. Further, the travel control device 10 includes the braking command output unit 105 configured to output an braking command for generating an independent braking force in each of a plurality of wheel cylinders 34 in order to generate a moment shortage corresponding to a difference between the target moment and the limit moment when the target moment is greater than the limit moment. According to the above configurations, when a turning moment is insufficient due to at least the behavior response delay, it is possible to compensate a shortage in the turning moment using the wheel cylinders 34 having a relatively higher responsiveness, thereby causing the vehicle V to more accurately travel along the target path.

Further, according to the embodiment, the behavior response delay includes delay based on a kinematic characteristic of the vehicle and delay based on mechanical or electrical operation of the steering mechanism 20, and the second arithmetic unit 104 calculates the limit moment while taking into account the two types of delay and the steering ability, which the steering mechanism 20 can exhibit in accordance with the condition of the vehicle V. Therefore, it is possible to more accurately calculate the limit moment by taking into account the behavior response delay and the steering ability of the steering mechanism.

Further, according to the embodiment, the condition of the vehicle V includes a current steering angle of the vehicle V, and the steering ability of the steering mechanism 20 includes a maximum steering angle, which is determined in relation to the current steering angle of the vehicle V and can be applied to the vehicle V at the current position by the steering mechanism 20. Therefore, it is possible to more accurately evaluate the steering ability of the steering mechanism 20.

Although the embodiments of the disclosure have been described above, the embodiments are presented by way of example and are not intended to limit the scope of the disclosure. These novel embodiments can be implemented in various other modes, and also various omissions, substitutions and changes therein can be made without departing from the spirit and scope of the disclosure. These embodiments and modifications thereof are encompassed in the spirit and scope of the disclosure and are also encompassed in the disclosure described in the claims and the equivalent scope thereof.

For example, in the foregoing embodiments, the case where calculated values of the moments are used as values required to realize the path tracking control taking the behavior response delay into account has been illustrated as one example. However, the technique of the embodiments can be similarly applied to a case where calculated values of yaw rates are used instead of or in addition to the calculated values of the moments.

1. A travel control device comprising:
a first arithmetic unit configured to calculate a target moment, which is a turning moment required to cause a vehicle to turn and move from a current position to a target position along a target path;
a second arithmetic unit configured to calculate a limit moment, which is a maximum turning moment which can be generated by a steering mechanism of the vehicle until the vehicle arrives at the target position from the current position, while taking at least a behavior response delay of the vehicle into account; and
an output unit configured to output a braking command for generating an independent braking force in a brake device provided for each of a plurality of wheels of the vehicle in order to generate a moment shortage corresponding to a difference between the target moment and the limit moment when the target moment is greater than the limit moment.

2. The travel control device according to claim 1, wherein the behavior response delay comprises a first delay based on a kinematic characteristic of the vehicle and a second delay based on mechanical or electrical operation of the steering mechanism,
wherein the second arithmetic unit calculates the limit moment while taking into account the first delay, the second delay and a steering ability, which the steering mechanism can exhibit in accordance with a condition of the vehicle.

3. The travel control device according to claim 2, wherein the condition of the vehicle comprises a current steering angle of the vehicle,
wherein the steering ability comprises a maximum steering angle, which is determined in relation to the current steering angle of the vehicle and can be applied to the vehicle by the steering mechanism.
